(19) United States
(12) Patent Application Publication
(10) Pub. No.: US 2013/0337893 A1
(43) Pub. Date: Dec. 19, 2013

(54) GAMING SYSTEM AND A METHOD OF GAMING

(71) Applicant: Aristocrat Technologies Australia Pty Limited, North Ryde (AU)

(72) Inventor: Edward Steven Riede, Las Vegas, NV (US)

(21) Appl. No.: 13/919,562

(22) Filed: Jun. 17, 2013

Related U.S. Application Data
(60) Provisional application No. 61/660,939, filed on Jun. 18, 2012.

(51) Int. Cl. G07F 17/32

(52) U.S. Cl. CPC G07F 17/3244
USPC 463/25

(57) ABSTRACT

Gaming systems are disclosed that include a game implementer arranged to implement a game, an outcome determiner arranged to determine whether an outcome of the game corresponds to a winning outcome, and a prize allocator arranged to allocate a monetary prize to a player when a winning outcome is determined to exist. The example gaming system is arranged to maintain a record of the tax withholding amount (TWA) for a player based on player money in and player money out values for the player over a plurality of games. Corresponding methods are also disclosed.

### CROSS-REFERENCE TO RELATED APPLICATIONS

The present application claims the benefit of priority to U.S. Provisional Patent Application No. 61/660,939, filed on Jun. 18, 2012, entitled “A GAMING SYSTEM AND A METHOD OF GAMING”, which is herein incorporated by reference in its entirety.

### FIELD OF THE INVENTION

The present invention relates to a gaming system and to a method of gaming.

### BACKGROUND

It is known to provide a gaming system which includes a game controller arranged to randomly display several symbols from a predetermined set of symbols and to determine a game outcome such as a game win based on the displayed symbols. In some arrangements, a win outcome is defined on the basis of occurrence of symbols along defined win lines which may be preselected or selected by a player prior to display of symbols by the gaming system.

Such gaming systems may commonly be implemented as a stepper machine provided with reels with each reel carrying several symbols of the set, or a video machine wherein selected symbols are displayed on virtual reels on a graphical display device.

In some jurisdictions it is a legislative requirement that if a win outcome provides a player with a monetary win amount above a defined threshold, in the United States $1,200, a win/loss statement covering the win amount must be submitted to tax authorities at the end of the financial year.

In order to implement this in a gaming establishment, a common practice when a prize amount above a defined threshold occurs at a gaming machine is to lock up the gaming machine and prevent further game play until tax documentation has been completed.

However, this process is cumbersome for both the casino operators and game players. In addition, revenue time for casino operators and game play time for game players is lost.

### BRIEF SUMMARY

In accordance with a first aspect of the present invention, there is provided a gaming system including:

a game implementer arranged to implement a game;

an outcome determiner arranged to determine whether an outcome of the game corresponds to a winning outcome;

a prize allocator arranged to allocate a monetary prize to a player when a winning outcome is determined to exist;

the gaming system being arranged to maintain a record of the tax withholding amount (TWA) for a player based on player money in and player money out values for the player over a plurality of games.

In one embodiment, the gaming system includes a portable storage device associated with a player, the portable storage device arranged to store the record of the tax withholding amount (TWA), and the gaming system includes a storage device read/write device.

In one embodiment, the portable storage device includes a tax withholding card and the storage device read/write device includes a card read/write device.

In one embodiment, the portable storage device includes a portable disk drive or a secure digital (SD) card.

In addition or alternatively, the gaming system includes a networked storage device arranged to store the record of the tax withholding amount (TWA).

In one embodiment, the gaming system is arranged to store on the storage device information indicative of the current tax withholding rate (WR), the total player money input (PMI) into one or more gaming machines associated with the system, and/or the total player money output (PMO) from the one or more associated gaming machines.

In one embodiment, the gaming system includes at least one credit meter arranged to track the amount of credit input into a gaming machine by a player during a game session and remaining for game play, and the gaming system is arranged to calculate a current required tax withholding amount (CRWA) based on the amount of remaining credit recorded in the credit meter, the tax withholding rate (WR), the total player money in value (PMI) stored on storage device, and the total player money out value (PMO) stored on the storage device.

In one embodiment, the gaming system is arranged to calculate a player surplus tax (PST) indicative of a tax withholding amount excess to the current required tax withholding amount (CRWA) and that can be during game play based on the tax withholding amount (TWA) and the current required tax withholding amount (CRWA), and to make the player surplus tax (PST) available to the player for game play.

In one embodiment, the gaming system is arranged to modify the tax withholding amount (TWA) on the storage card to correspond to the required tax withholding amount (RTWA) at cash out.

The gaming system may be implemented as a stand alone gaming machine or across a network.

In accordance with a second aspect of the present invention, there is provided a method of gaming including:

implementing a game;

determining whether an outcome of the game corresponds to a winning outcome;

allocating a monetary prize to a player when a winning outcome is determined to exist; and

maintaining a record of the tax withholding amount (TWA) for a player based on player money in and player money out values for the player over a plurality of games.

In accordance with a third aspect of the present invention, there is provided a computer program arranged when loaded into a computer to instruct the computer to operate in accordance with a gaming system according to the first aspect of the present invention.

In accordance with a fourth aspect of the present invention, there is provided a computer readable medium having computer readable program code embodied therein for causing a computer to operate in accordance with a gaming system according to the first aspect of the present invention.

In accordance with a fifth aspect of the present invention, there is provided a data signal having computer readable program code embodied therein for causing a computer to operate in accordance with a gaming system according to the first aspect of the present invention.

### BRIEF DESCRIPTION OF THE DRAWINGS

Certain embodiments of the present invention will now be described, by way of example only, with reference to the accompanying drawings, in which:

FIG. 1 is a schematic block diagram of functional components of a gaming system in accordance with an embodiment of the present invention;

FIG. 2 is a diagrammatic representation of a gaming system in accordance with an embodiment of the present invention with the gaming system implemented in the form of a stand alone gaming machine;

FIG. 3 is a schematic block diagram of operative components of the gaming machine shown in FIG. 2;

FIG. 4 is a schematic block diagram of components of a memory of the gaming machine shown in FIG. 2;

FIG. 5 is a schematic diagram of a gaming system in accordance with an alternative embodiment of the present invention with the gaming system implemented over a network;

FIG. 6 is a flow diagram illustrating a method of managing gaming tax liability in a gaming system in accordance with an embodiment of the present invention; and

FIG. 7 is a flow diagram illustrating a conventional method of managing gaming tax liability in a gaming system.

In addition, the drawings are for the purpose of illustrating example embodiments, but it is understood that the present disclosure is not limited to the arrangements and instrumentality shown in the drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in at least one embodiment, at least one of the elements is hereby expressly defined to include a tangible medium such as a memory, DVD, CD, etc. storing the software and/or firmware.

These embodiments and many additional embodiments are described more below. Further, the detailed description is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure may be practiced without certain, specific details. In other instances, well known methods, procedures, components, and circuitry have not been described in detail to avoid unnecessarily obscuring aspects of the embodiments.

Reference herein to “embodiment” means that a particular feature, structure, or characteristic described in connection with the embodiment can be included in at least one example embodiment of the invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, may be combined with other embodiments.

The present gaming system operates such that at least during some game implementations, the gaming system is arranged to track player wins and losses and maintain a record of the required tax withholding amount (RWA) appropriate for the player. In one embodiment, a record of the required tax withholding amount (RWA) is maintained on a portable device carried by the player, for example on a machine readable card. In an alternative embodiment, the required tax withholding amount (RWA) is maintained on a remote server in networked communication with the player operable gaming machines.

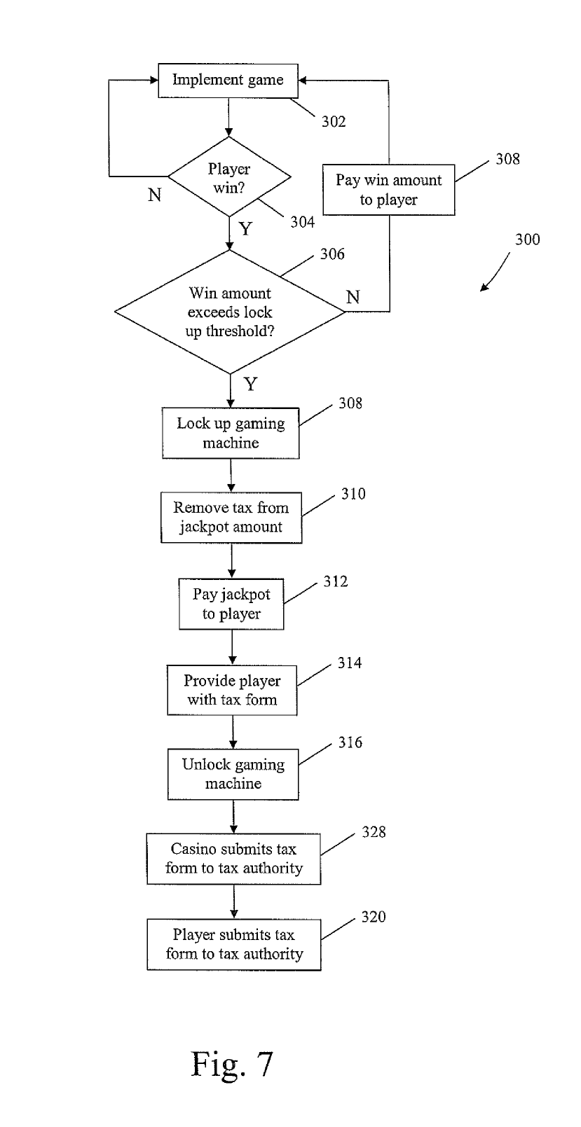

In at least some jurisdictions, it is a legislated requirement that tax is withheld on win amounts greater than a defined threshold, for example $1,200. In a particular known example illustrated by steps 302 to 320 in flow diagram 300 shown in FIG. 7, when a player wins a monetary amount that exceeds a threshold 304, 306, the gaming machine on which the amount was won is locked 308 so that no further games may be implemented. The player then has the option of either deducting the appropriate tax amount from the win amount 310, to be forwarded to tax authorities, or of delaying payment of the tax withholding amount until required by the tax authority, for example at the end of the tax year. The player is then provided 314 with a gaming tax form required for submission to the tax authority, in the United Sates a w2-G form, and the gaming machine is unlocked so that normal play can continue. The operator of the gaming machine, which may be a casino, then provides 318 the tax authorities with a tax form, in the United States a w2-G form, and at the appropriate time the player provides 320 the tax authorities with a win/loss statement including a gaming tax form, in the United States a w2-G form.

Certain embodiments of the present invention operate so as to avoid the requirement to lock a gaming machine each time a significant win amount is obtained for a player by recording a current tax withholding amount for the player. The tax withholding amount is dependent on the total player money in (PMI) and the total player money out (PMO) for gaming machines played by the player. In this way, an accurate record is established for tax liability for the player that may be used in a win/loss statement at the end of the tax year. As a consequence, gaming machine lockups are avoided and only one tax form, in the United States a w2-G form, is involved.

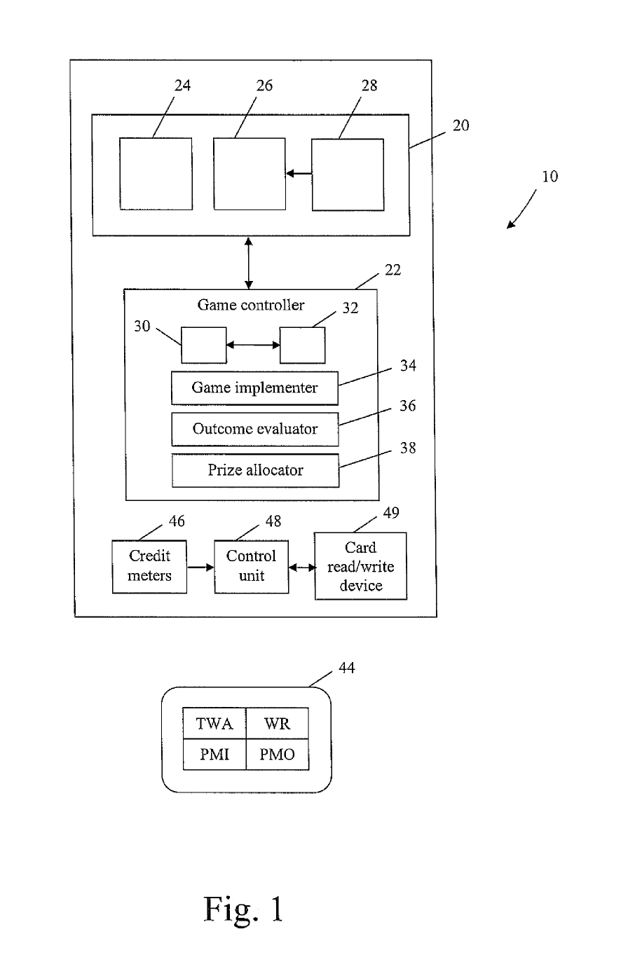

Referring to the drawings, in FIG. 1 there is shown a schematic block diagram of a gaming system 10 arranged to implement a probabilistic game of the type wherein several symbols from a set of symbols are randomly displayed, and a game outcome is determined on the basis of the displayed symbols. The system may have a single mode of operation or may be of the type including multiple game modes such as operable in normal game mode wherein a base game is implemented and special game mode wherein a feature game is implemented.

With some such probabilistic games, the set of symbols used during normal game mode include standard symbols and function symbols, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display along a win line, or are displayed according to defined outcome patterns such as scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

Referring to FIG. 1, a schematic diagram of components of a gaming system 10 in accordance with the present embodiment is shown. The components include a player interface 20 and a game controller 22.

The player interface 20 is arranged to enable interaction between a player and the gaming system and for this purpose includes input/output components for the player to enter instructions and play the game.

Components of the player interface 20 may vary but will typically include a credit mechanism 24 to enable a player to input credits and receive payouts, one or more displays 26 which may include a touch screen, and a game play mechanism 28 arranged to enable a player to input game play instructions.

The game controller 22 is in data communication with the player interface 20 and is arranged to implement a game, for example of the type wherein a plurality of symbols are selected from a set of symbols and the selected symbols used to determine game outcomes. Typically, the game controller 22 includes a processor 30 arranged to process game play instructions and output game player outcomes to the display 26. Typically, the game play instructions are stored as program code in a memory 32 that can also be hardwired. It will be understood that in this specification the term “processor” is used to refer generically to any device that can process game play instructions and may include a microprocessor, microcontroller, programmable logic device or other computational device such as a personal computer or a server.

The game controller 32 includes a game implementer 34 arranged to implement a game, an outcome evaluator 36 arranged to evaluate an outcome of the game and determine whether the game outcome corresponds to a winning outcome, and a prize allocator 38 arranged to allocate a monetary prize to a player when a winning outcome is determined to exist. In this example, the game implementer 34, the outcome evaluator 36, and the prize allocator 38 are implemented using the processor 30 and memory 32, although it will be understood that other implementations are envisaged.

The gaming system 10 is also arranged to maintain a record of the relevant tax withholding amount (TWA) for each player and to dynamically modify the recorded tax withholding amount (TWA) based on the amount of credit input into the gaming machine and the amount of credit dispensed from the gaming machine.

In the present example, a record of the tax withholding amount (TWA) is stored on a portable player tax withholding device. The tax withholding device may include a player tax withholding card 44 arranged to store the tax withholding amount (TWA) together with a record of the current legislated tax withholding rate (WR), the total player money input (PMI) into gaming machines associated with the system, for example for the current tax year, and the total player money output (PMO) from associated gaming machines, for example for the current tax year.

While certain embodiments of the present invention are described in relation to a tax withholding card usable to maintain a record of the current tax withholding amount for a player, it will be understood that other arrangements are possible. For example, the tax withholding device may include a portable storage device such as an SD card or a USB drive.

The gaming system 10 also includes one or more credit meters 46 used to monitor the available player credit in the gaming machine, and a control unit 48 for controlling and coordinating interactions with the tax withholding card 44. In particular, the control unit 48 calculates a required tax withholding amount (RWA) based on the amount of credit recorded in the credit meters 46, the total player money in value (PMI) stored on the card 44 and the total player money out value (PMO) stored on the card 44. The control unit 48 also modifies the tax withholding amount (TWA) on the card 44 as required at cash out.

While in the present embodiment, the gaming system 10 includes the control unit 48 for carrying out the tax withholding card functions, it will be understood that other arrangements are possible. For example such functions may be carried out by the processor 40.

In order to facilitate communications with the card 44, the gaming system 10 in this example includes a card read/write device 49 arranged to write data to and read data from a player tax withholding card 44 under control of the control unit 48.

The gaming system 10 can take a number of different forms.

In a first form, a stand alone gaming machine is provided wherein all or most components to implement the game are present in a player operable gaming machine.

In a second form, a distributed architecture is provided wherein some of the components to implement the game are present in a player operable gaming device and some of the components to implement the game are located remotely relative to the gaming device. For example, a “thick client” architecture may be used wherein part of the game is executed on a player operable gaming terminal and part of the game is executed remotely, such as by a gaming server; or a “thin client” architecture may be used wherein most of the game is executed remotely such as by a gaming server and a player operable gaming terminal is used only to display audible and/or visible gaming information to the player and receive gaming inputs from the player.

However, it will be understood that other arrangements are envisaged. For example, an architecture may be provided wherein a gaming device is networked to a gaming server and the respective functions of the gaming device and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

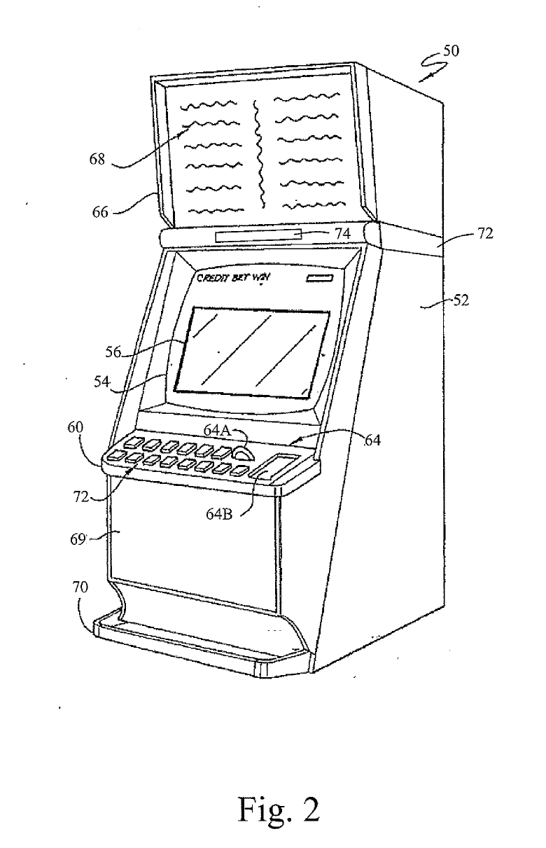

A gaming system in the form of a stand alone gaming machine 50 is illustrated in FIG. 2. The gaming machine 50 includes a console 52 having a display 54 on which is displayed representations of a game 56 that can be played by a player. A mid-trim 60 of the gaming machine 50 houses a bank of buttons 62 for enabling a player to interact with the gaming machine, in particular during game play. The mid-trim 60 also houses a credit input mechanism 64 which in this example includes a coin input chute 64A and a bill collector 64B. Other credit input mechanisms may also be employed, for example, a card reader for reading a smart card, debit card or credit card.

A top box 66 may carry artwork 68, including for example pay tables and details of bonus awards and other information or images relating to the game. Further artwork and/or information may be provided on a front panel 69 of the console 52. A coin tray 70 is mounted beneath the front panel 69 for dispensing cash payouts from the gaming machine 50.

The display 54 is in the form of a video display unit, particularly a cathode ray tube screen device. Alternatively, the display 54 may be a liquid crystal display, plasma screen, or any other suitable video display unit. The top box 66 may also include a display, for example a video display unit, which may be of the same type as the display 54, or of a different type.

The display 54 in this example is arranged to display representations of several reels, each reel of which has several associated symbols. Typically 3, 4 or 5 reels are provided. During operation of the game, the reels first appear to rotate then stop with typically three symbols visible on each reel. Game outcomes are determined on the basis of the visible symbols together with any special functions associated with the symbols.

A player marketing module (PMM) 72 having a display 74 is connected to the gaming machine 50. The main purpose of the PMM 72 is to allow the player to interact with a player loyalty system. The PMM 72 has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PMM 72 is a Sentinel III device produced by Aristocrat Technologies Pty Ltd.

The PMM 72 may be configured so as to interact with the player tax withholding card 44 in order to maintain a current tax withholding amount (TWA) for a player on the player's card 44, and in one embodiment the player tracking device is arranged to also hold tax withholding data, including the current tax withholding amount (TWA), the legislated tax withholding rate (WR), the total player money input into associated gaming machines (PMI), and the total player money output from associated gaming machines (PMO).

In an alternative embodiment, tax withholding account functions are implemented separate to the PMM 72, for example using a separate car read/write device and associated control, as shown in FIG. 1.

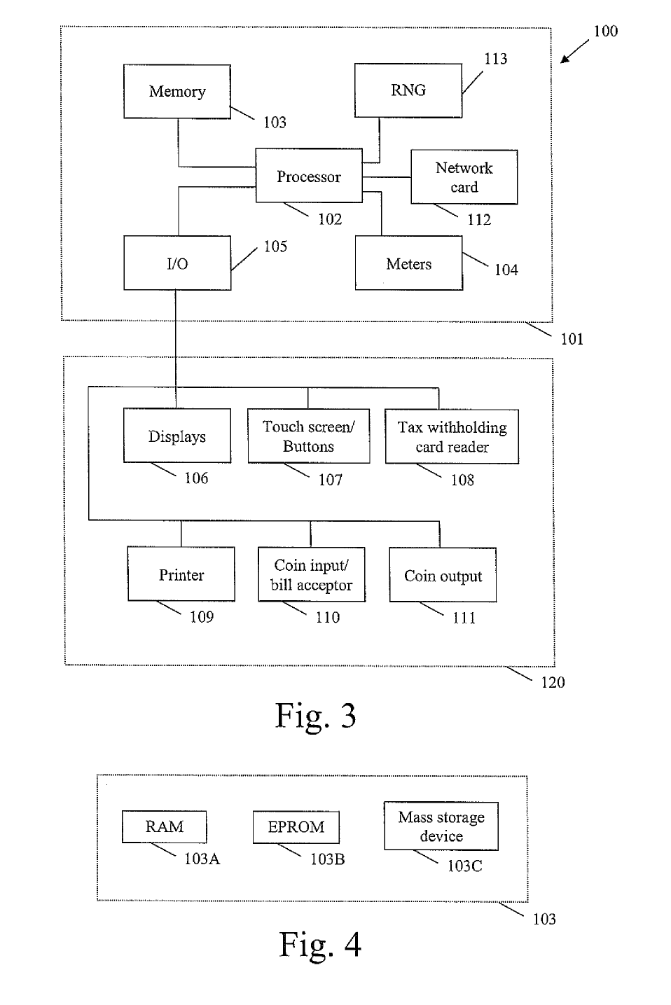

FIG. 3 shows a block diagram of operative components of a gaming device 100 which may be the same as or different to the gaming machine shown in FIG. 2.

The gaming device 100 includes a game controller 101 having a processor 102. Instructions and data to control operation of the processor 102 in accordance with certain embodiments of the present invention are stored in a memory 103 which is in data communication with the processor 102.

Typically, the gaming device 100 will include both volatile and non-volatile memory and more than one of each type of memory, with such memories being collectively represented by the memory 103.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

The gaming device has hardware meters 104 for purposes including ensuring regulatory compliance and monitoring player credit, an input/output (I/O) interface 105 for communicating with a player interface 120 of the gaming device 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 3, the peripheral devices that communicate with the game controller 101 include one or more displays 106, a touch screen and/or bank of buttons 107, a tax withholding card reader 108, a printer 109, a bill acceptor and/or coin input mechanism 110 and a coin output mechanism 111. Additional hardware may be included as part of the gaming machine 100, or hardware may be omitted based on the specific implementation.

In addition, the gaming device 100 may include a communications interface, for example a network card 112. The network card may, for example, send status information, accounting information or other information to a central controller, server or database and receive data or commands from the central controller, server or database.

It is also possible for the operative components of the gaming device 100 to be distributed, for example input/output devices 106,107,108,109,110,111 may be provided remotely from the game controller 101.

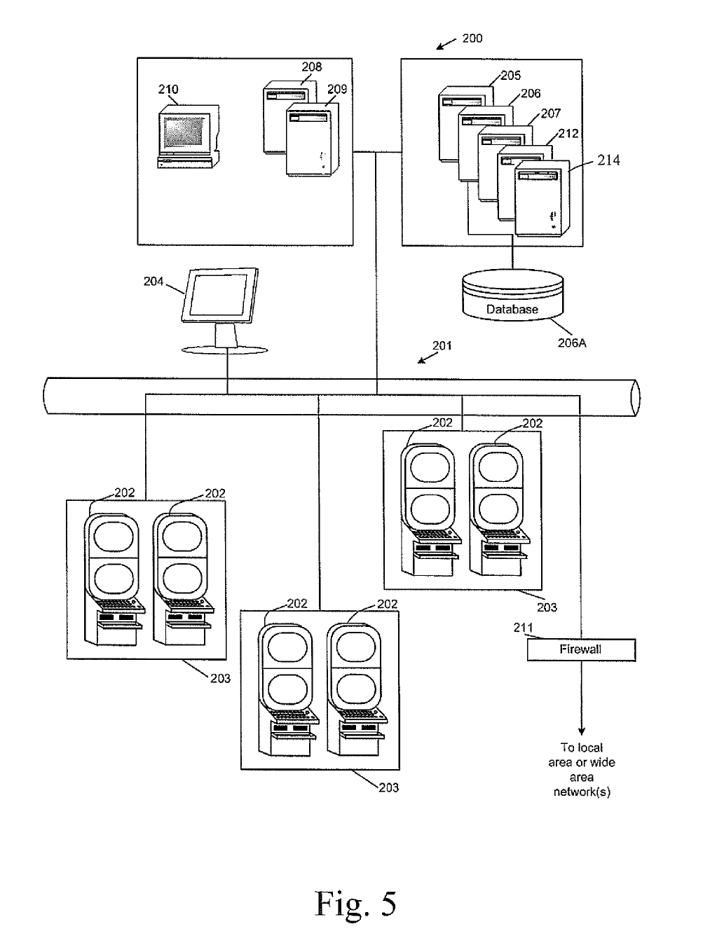

FIG. 5 shows a gaming system 200 in accordance with an alternative embodiment. The gaming system 200 includes a network 201, which for example may be an Ethernet network, a LAN or a WAN. In this example, three banks 203 of two gaming devices 202 are connected to the network 201. The gaming devices 202 provide a player operable interface and may be the same as the gaming machines 50,100 shown in FIGS. 2 and 3, or may have simplified functionality depending on the rules, requirements, guidelines, and/or preferences for implementing game play. While banks 203 of two gaming devices are illustrated in FIG. 5, banks of one, three or more gaming devices are also envisaged.

One or more displays 204 may also be connected to the network 201. The displays 204 may, for example, be associated with one or more banks 203 of gaming devices. The displays 204 may be used to display representations associated with game play on the gaming devices 202, and/or used to display other representations, for example promotional or informational material.

In a thick client embodiment, a game server 205 implements part of the game played by a player using a gaming device 202 and the gaming device 202 implements part of the game. With this embodiment, as both the game server 205 and the gaming device 202 implement part of the game, they collectively provide a game controller. A database management server 206 may manage storage of game programs and associated data for downloading or access by the gaming devices 202 in a database 206A.

The gaming system 200 also includes a jackpot server 207 arranged to manage a progressive bonus of the type wherein each gaming machine 202 associated with the progressive bonus contributes to a bonus pool based on defined criteria. For example, each gaming machine may contribute a defined proportion of turnover to the bonus pool, or each gaming machine may be arranged to allocate a credit amount to the bonus pool based on defined criteria, such as based on occurrence of defined game outcomes. The progressive bonus operates such that a player of any of the associated gaming machines may win at least a portion of the bonus pool when a defined winning outcome occurs at the gaming machine.

In a variation of the above thick client embodiment, the gaming device 202 is a gaming machine arranged to implement the game, with the game server 205 functioning merely to serve data indicative of a game to the gaming machine 202 for implementation.

With this implementation, a data signal containing a computer program usable by the gaming machine to implement the gaming system may be transferred from the game server to the client terminal, for example in response to a request by the gaming machine.

In a thin client embodiment, the game server 205 implements most or all of the game played by a player using a gaming terminal 202 and the gaming terminal 202 essentially provides only the player interface. With this embodiment, the game server 205 provides the game controller. The gaming terminal will receive player instructions, and pass the instructions to the game server which will process them and return game play outcomes to the gaming terminal for display. In a thin client embodiment, the gaming terminal could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

A loyalty program server 212 may also be provided.

The gaming system 200 also includes a tax withholding server 214 arranged to store tax withholding amounts TWA for multiple players, together with a record of the current legislated tax withholding rate (WR), the total player money input (PMI) into gaming machines associated with the system, for example for the current tax year, and the total player money output (PMO) from associated gaming machines, for example for the current tax year. The tax withholding server 214 may be in addition to or instead of a withholding card read/write device.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine. Alternatively, a separate random number generator server could be provided.

Examples of specific implementations of the gaming system will now be described.

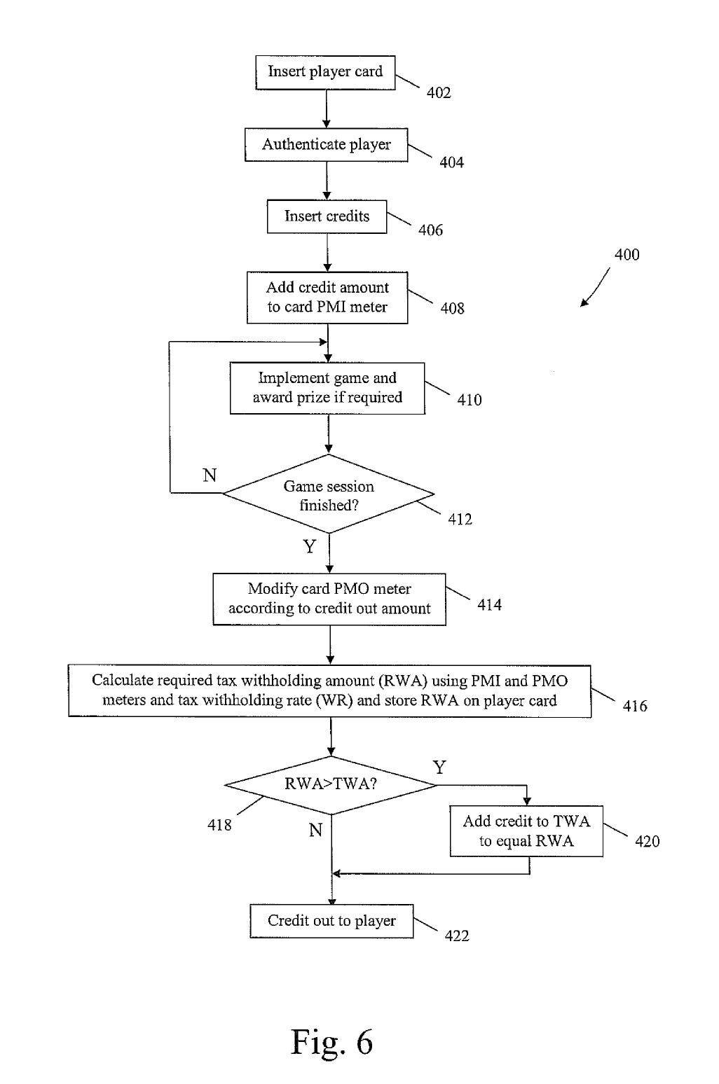

FIG. 6 shows a flow diagram 400 illustrating a method of managing gaming tax liability using the present gaming system. The example is described in relation to an embodiment wherein a player is provided with a portable tax withholding card 44 and the gaming system has a tax withholding car reader 49. However, it will be understood that other implementations are possible, for example wherein tax withholding information is stored remotely on a tax withholding server.

Before commencing game play at a player operable gaming machine, the player first inserts 402 his/her tax withholding card 44 into the card reader 49. As indicated at step 404, the player then undergoes an authentication process whereby the player typically enters username and password information. A reference username and password for comparison purposes may be stored on the tax withholding card 44 or elsewhere on the gaming system, for example on a remote tax withholding server 214 shown in FIG. 5.

As indicated at step 406, after successful authentication, the player then inserts credit into the gaming machine and the input credit is identified by the relevant gaming machine credit meter. The credit in amount is added 408 to a player money in value PMI stored on the tax withholding card 44.

One or more games are implemented by the gaming machine until the game session finishes, either because the player has opted to cease game play prior to expending all of the credit in amount, or because the credit has reduced to zero. After the game session finishes 412, a player money out value PMO stored on the tax withholding card 44 is modified 414 according to the credit out amount if any.

It will be understood therefore that the PMI and PMO values stored on the tax withholding card 44 represent the total money inserted into gaming machines associated with the system and the total money taken out of the gaming machines over a defined period such as a particular tax year.

As indicated at step 416, the PMI and PMO values and a tax withholding rate value WR stored on the card 44 are used to calculate a current required tax withholding amount RWA, as follows:

RWA=(PMO−PMI)*WR

If the stored tax withholding amount TWA>0 prior to commencement of a game session, and during a game session the player has lost all of the money inserted into the gaming machine, then the required withholding amount RWA will be less than the tax withholding amount TWA. The excess credit represented by TWA-RWA may be returned to the player as a cash out, as additional credits for game play, or may be withheld by the player to be refunded by the tax authorities at the end of the tax year.

The player money out value PMO is not modified until cash out. In order to ensure that the TWA is always large enough during a game, a current player money out value CPMO is calculated and, during the game, a current required withholding amount CRWA representing the withholding amount that would be required if a player cashes out is calculated. CPMO and CRWA are given by:

CPMO=PMO+credit_meter

CRWA=(CPMO−PMI)*WR

The player surplus tax (PST) is the extra amount during game play that can be removed from the TWA stored on the card 44. PST is given by:

PST=TWA−CRWA

If the player surplus tax PST>0, then the PST amount could be used as credit in the gaming machine immediately. In other words, no further withholding would be required if a cash out occurred.

The maximum tax bonus amount (MTBA) is given by:

MTBA=PST*(1+WR)

The MTBA is the amount required for RWA=TWA if the player loses all of the credit in money.

In will be understood that the present gaming system provides many advantages to the tax authorities, gaming operators and players. For example, the system ensures that all taxable wins are fairly accounted for, the number of tax forms are minimized since only one such form is required at the end of the tax year, and players are provided with the opportunity to use excess withheld tax for gaming should the required tax withholding amount reduce during game play.

A further advantage is that gaming machine lockups are avoided and as a consequence gaming machine down time and player inconvenience is minimized

In the claims of this application and in the description of certain embodiments of the present invention, except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. It will be understood that the invention disclosed and defined in this specification extends to all alternative combinations of two or more of the individual features mentioned or evident from the text or drawings. All of these different combinations constitute various alternative aspects of the invention.

The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM, Blu-Ray, and/or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A gaming system comprising:
a game implementer arranged to implement a game;
an outcome determiner arranged to determine whether an outcome of the game corresponds to a winning outcome;
a prize allocator arranged to allocate a monetary prize to a player when a winning outcome is determined to exist;
the gaming system being arranged to maintain a record of the tax withholding amount (TWA) for a player based on player money in and player money out values for the player over a plurality of games.

2. A gaming system as claimed in claim 1, comprising a portable storage device associated with the player and a storage device read/write device, the portable storage device arranged to store the record of the tax withholding amount (TWA).

3. A gaming system as claimed in claim 2, wherein the portable storage device comprises a tax withholding card and the storage device read/write device comprises a card read/write device.

4. A gaming system as claimed in claim 2, wherein the portable storage device comprises a portable disk drive or a secure digital (SD) card.

4. A gaming system as claimed in claim 1, comprising a networked storage device arranged to store the record of the tax withholding amount (TWA).

5. A gaming system as claimed in claim 1, wherein the gaming system is arranged to store on the storage device information indicative of the current tax withholding rate (WR), the total player money input (PMI) into one or more gaming machines associated with the system, and/or the total player money output (PMO) from the one or more associated gaming machines.

6. A gaming system as claimed in claim 5, comprising at least one credit meter arranged to track the amount of credit input into a gaming machine by a player during a game session and remaining for game play, and the gaming system is arranged to calculate a current required tax withholding amount (CRWA) based on the amount of remaining credit recorded in the credit meter, the tax withholding rate (WR), the total player money in value (PMI) stored on storage device, and the total player money out value (PMO) stored on the storage device.

7. A gaming system as claimed in claim 6, wherein the gaming system is arranged to calculate a player surplus tax (PST) indicative of a tax withholding amount excess to the current required tax withholding amount (CRWA) and that can be during game play based on the tax withholding amount (TWA) and the current required tax withholding amount (CRWA), and to make the player surplus tax (PST) available to the player for game play.

8. A gaming system as claimed in claim 1, wherein the gaming system is arranged to modify the tax withholding amount (TWA) on the storage card at cash out.

9. A gaming system as claimed in claim 1, wherein the gaming system is implemented as a stand alone gaming machine or across a network.

10. A method of gaming comprising:
implementing a game;
determining whether an outcome of the game corresponds to a winning outcome;
allocating a monetary prize to a player when a winning outcome is determined to exist; and
maintaining a record of the tax withholding amount (TWA) for a player based on player money in and player money out values for the player over a plurality of games.

11. A method as claimed in claim 10, comprising storing the record of the tax withholding amount (TWA) on a portable storage device associated with a player.

12. A method as claimed in claim 11, comprising storing the record of the tax withholding amount (TWA) on a tax withholding card.

13. A method as claimed in claim 11, comprising storing the record of the tax withholding amount (TWA) on a portable disk drive or a secure digital (SD) card.

14. A method as claimed in claim 10, comprising storing a record of the tax withholding amount (TWA) on a networked storage device.

15. A method as claimed in claim 10, comprising storing on the storage device information indicative of the current tax withholding rate (WR), the total player money input (PMI) into one or more gaming machines associated with the system, and/or the total player money output (PMO) from the one or more associated gaming machines.

16. A method as claimed in claim 15, comprising tracking the amount of credit input into a gaming machine by a player during a game session and remaining for game play, and calculating a current required tax withholding amount (CRWA) based on the amount of remaining credit recorded in the credit meter, the tax withholding rate (WR), the total player money in value (PMI) stored on storage device, and the total player money out value (PMO) stored on the storage device.

17. A method as claimed in claim 16, comprising calculating a player surplus tax (PST) indicative of a tax withholding amount excess to the current required tax withholding amount (CRWA) and that can be during game play based on the tax withholding amount (TWA) and the current required tax withholding amount (CRWA), and making the player surplus tax (PST) available to the player for game play.

18. A method as claimed in claim 10, comprising modifying the tax withholding amount (TWA) on the storage card at cash out.

19. A tangible computer readable storage medium having computer readable program code embodied therein which, when executed, cause a computer to operate in accordance with a gaming system comprising:
a game implementer arranged to implement a game;
an outcome determiner arranged to determine whether an outcome of the game corresponds to a winning outcome;
a prize allocator arranged to allocate a monetary prize to a player when a winning outcome is determined to exist;
the gaming system being arranged to maintain a record of the tax withholding amount (TWA) for a player based on player money in and player money out values for the player over a plurality of games.

20. A tangible computer readable storage medium having computer readable program code embodied therein which, when executed, cause a computer to implement a method comprising:
implementing a game;
determining whether an outcome of the game corresponds to a winning outcome;
allocating a monetary prize to a player when a winning outcome is determined to exist; and
maintaining a record of the tax withholding amount (TWA) for a player based on player money in and player money out values for the player over a plurality of games.
